(19) United States
(12) Patent Application Publication
(10) Pub. No.: US 2004/0046697 A1
(43) Pub. Date: Mar. 11, 2004

(54) Dual band antenna

(76) Inventors: Lung Sheng Tai, Tu-Chen (TW); Hsien-Chu Lin, Tu-Chen (TW); Chia-Ming Kuo, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/314,022

(22) Filed: Dec. 5, 2002

(30) Foreign Application Priority Data
Sep. 11, 2002 (TW) 09214233

(51) Int. Cl. H01Q 1/38; H01Q 1/24

(52) U.S. Cl. 343/700 MS; 343/702

(57) ABSTRACT

A dual band antenna (1) includes an insulative substrate (10), a planar conductive element disposed on the insulative substrate, and a feeder cable (14) electrically connecting to the conductive element. The conductive element includes a first radiating portion (11), a second radiating portion (12) and a ground portion (13). The first radiating portion operates in the 2.45 GHz frequency band and the second radiation portion operates in the 5.25 GHz frequency band. The first and the second radiating portions and the ground portion are all disposed in the same plane, thereby occupying a relatively small space in an electrical device.

### BACKGROUND OF THE INVENTION

1. Field of the Invention

The present invention relates to an antenna, and in particular to an antenna which is capable of operating in two distinct frequency bands.

2. Description of the Prior Art

There is a growing need for dual-frequency antennas for use in wireless communication devices to adapt the devices for dual-frequency operation. In particular, enabling a device to communicate both in the 2.45 GHz (IEEE 802.11b) and in the 5.25 GHz (IEEE 802.11a) frequency bands is desirable. Several conventional dual-frequency planar antennas are disclosed in U.S. Pat. No. 6,002,367 and in a paper titled “Wide-Band E-Shaped Patch Antennas for Wireless Communications” by Fan Yang, Xue-Xia Zhang and Yahya Rahmat-Samii, IEEE Transactions on Antennas and Propagation, Volume 49, Number 7, July 2001, pp. 1094-1100. However, these antennas have high profiles, so occupy a relatively large space in an electrical device.

Hence, an improved antenna is desired to overcome the above-mentioned shortcomings of existing antennas.

### BRIEF SUMMARY OF THE INVENTION

A main object of the present invention is to provide a dual band antenna having a low profile.

A dual band, antenna in accordance with the present invention for an electronic device comprises an insulative substrate, a planar conductive element disposed on the insulative substrate, and a feeder cable electrically connecting to the conductive element. The conductive element comprises a first radiating portion, a second radiating portion, and a ground portion. The first and the second radiating portions, and the ground portion are all disposed in the same plane, thereby occupying a relatively small space in an electrical device.

Other objects, advantages and novel features of the invention will become more apparent from the following detailed description of a preferred embodiment when taken in conjunction with the accompanying drawings.

### BRIEF DESCRIPTION OF THE DRAWINGS

FIG. 1 is a top view of a first embodiment of a dual band antenna in accordance with the present invention, attached to a ground element of an electrical device;

FIG. 2 is a top view of the dual band antenna of FIG. 1, shown in isolation;

FIG. 3 is a test chart recording for the dual band antenna of FIG. 1, showing Voltage Standing Wave Ratio (VSWR) as a function of frequency;

FIG. 4 is a horizontally polarized principle plane radiation pattern (where the principle plane is an X-Y plane) of the dual band antenna of FIG. 1 operating at a frequency of 2.5 GHz;

FIG. 5 is a vertically polarized principle plane radiation pattern (where the principle plane is an X-Y plane) of the dual band antenna of FIG. 1 operating at a frequency of 2.5 GHz;

FIG. 6 is a horizontally polarized principle plane radiation pattern (where the principle plane is an X-Y plane) of the dual band antenna of FIG. 1 operating at a frequency of 5.35 GHz;

FIG. 7 is a vertically polarized principle plane radiation pattern (where the principle plane is an X-Y plane) of the dual band antenna of FIG. 1 operating at a frequency of 5.35 GHz;

FIG. 8 is a perspective view of a second embodiment of the present invention; and

FIG. 9 is a test chart recording for the dual band antenna of FIG. 8, showing VSWR as a function of frequency.

### DETAILED DESCRIPTION OF THE INVENTION

Reference will now be made in detail to a preferred embodiment of the present invention.

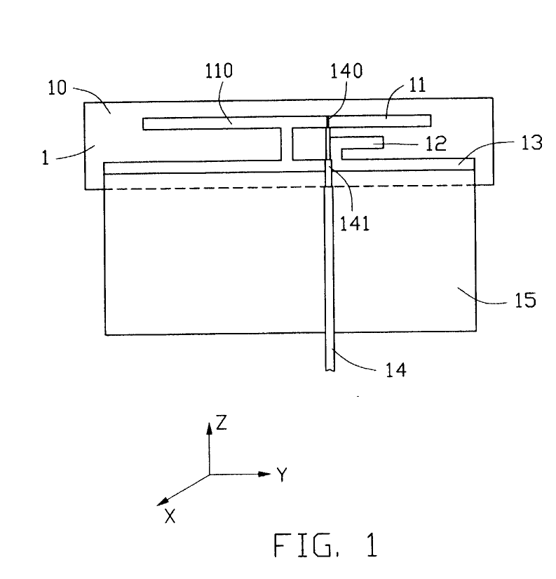

Referring to FIGS. 1, 2 and 3, a dual band antenna 1 in accordance with a first embodiment of the present invention comprises a flat and rectangular substrate 10, a planar conductive element (not labeled) disposed on an upper major surface of the substrate 10, and a coaxial feeder cable 14.

The substrate 10 can be formed from a dielectric material such as glass, including fused quartz, or ceramics, such as alumina or beryllia. It can also comprise an ordinary electronic substrate such as a printed circuit board or a flexible printed circuit board.

The conductive element comprises a ground portion 13, and a first radiating portion 11 and a second radiating portion 12 extending from the ground portion 13. The first and the second radiating portions 11, 12 and the ground portion 13 are all in the same plane and are configured to be strip-shaped. The ground portion 13 is horizontally disposed on the substrate 10. The first radiating portion 11 is T-shaped and extends from a middle section of a rear edge of the ground portion 13. The first radiating portion 11 comprises a first radiating segment 110 parallel to the ground portion 13, and a vertical first connection segment 111. The first connection segment 111 extends from a middle section of the first radiating segment 110 to the middle section of the ground portion 13. The second radiating portion 12 has an inverted L-shape and is partially surrounded by the first radiating portion 11. The second radiating portion 12 comprises a vertical second connection segment 121 parallel to the first connection segment 111 and a horizontal second radiating segment 120 parallel to the ground portion 13 and extending from a rear end of the second connection segment 121. The second connection segment 121 extends from a side section of the rear edge of the ground portion 13 and is adjacent to the first connection segment 111.

The coaxial feeder cable 14 has an inner core conductor 140 and an outer shield conductor 141 surrounding the inner core conductor 140. The inner core conductor 140 is soldered to the first radiating segment 110 of the first radiating portion 11 for transmitting signals between the dual band antenna 1 and a signal unit of an electrical device (not shown). The location of the solder point of the inner core conductor 140 on the first radiating portion 11 is predetermined to achieve a desired matching impedance for both frequency bands. The outer shield conductor 141 is soldered to the ground portion 13 for grounding the dual band antenna 1.

Referring to FIG. 1, in assembly, the dual band antenna 1 is assembled in an electrical device, such as a laptop computer (not shown), with a front edge of the ground portion 13 soldered to an electrically conductive ground element 15 of the electrical device. The ground portion 13 is substantially in the same plane as the ground element 15.

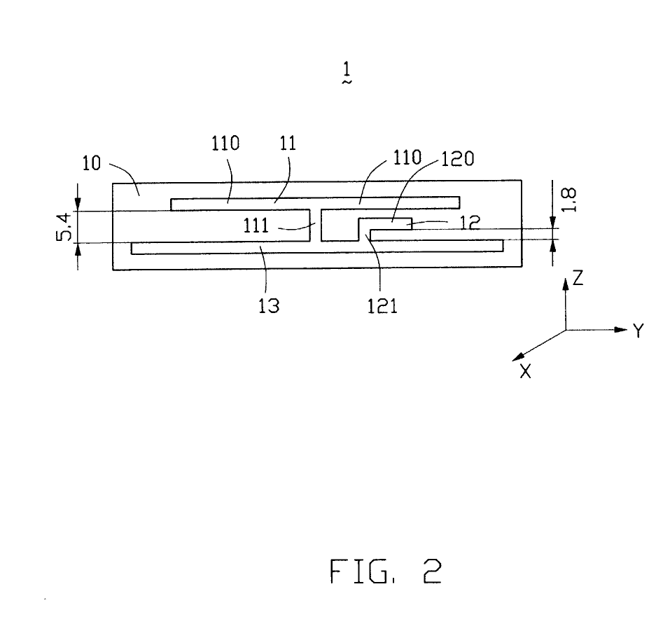

In the preferred embodiment, a length of the first radiating segment 110 is 49 mm. A distance between the first radiating segment 110 and the ground portion 13 is 5.4 mm (as shown in FIG. 2). A length of the second radiating segment 120 is 7 mm. A distance between the second radiating segment 120 and the ground portion 13 is 1.8 mm (as shown in FIG. 2). A distance between the first and the second radiating segments 110, 120 is 1.8 mm. The dimensions are such that each of the radiating portions 11, 12 is configured to resonate within a respective frequency band. For example, the first radiating portion 11 is configured to resonate between 2.38 GHz and 2.67 GHz (i.e. the 2.45 GHz frequency band). The second radiating portion 12 is configured to resonate between 5.02 GHz and 5.40 GHz (i.e., the 5.25 GHz frequency band). The first and second radiating portions 11, 12 constitute nearly independent regions having different resonant frequencies. This is an advantage where the dual band antenna must operate in different environments.

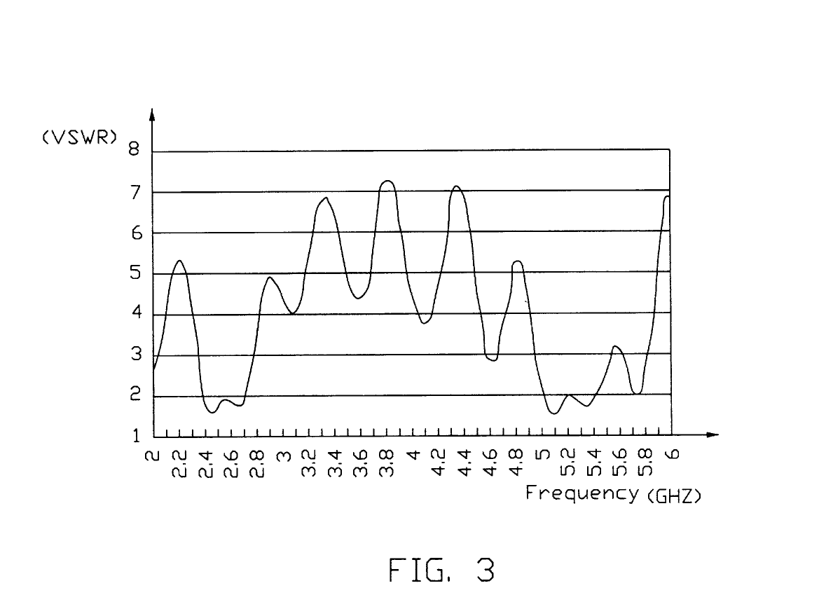

FIG. 3 shows a test chart recording of Voltage Standing Wave Ratio (VSWR) of the dual band antenna 1 as a function of frequency. Note that VSWR drops below the desirable maximum value “2” in the 2.45 GHz frequency band and in the 5.25 GHz frequency band, indicating acceptably efficient operation in these two frequency bands.

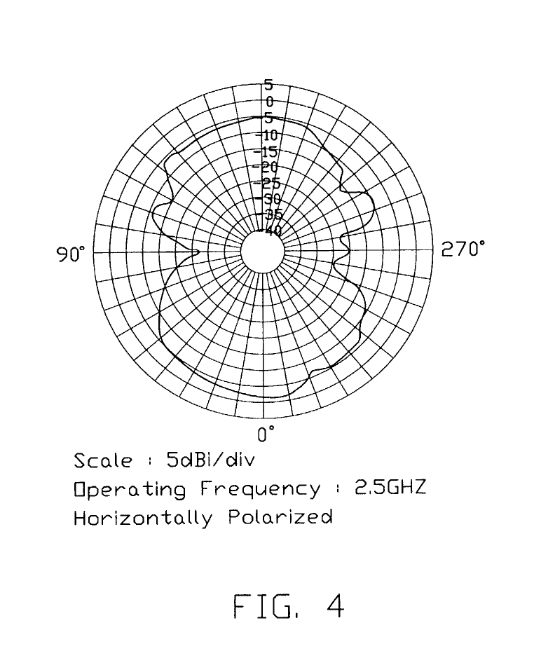

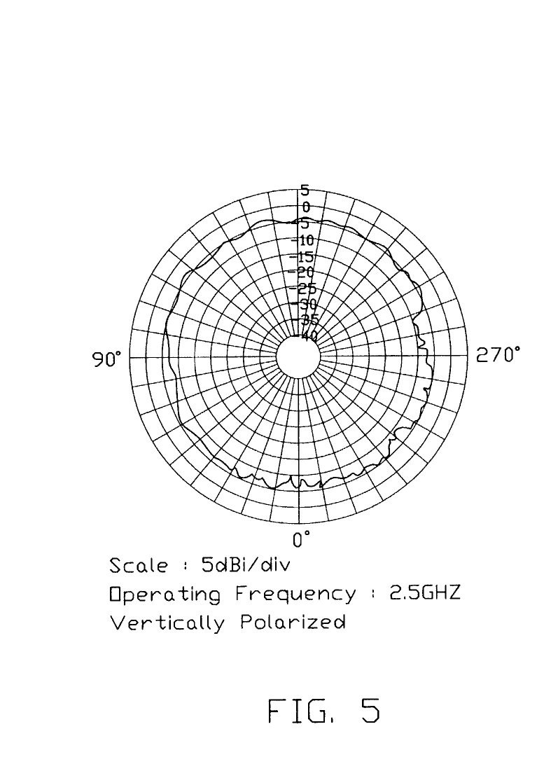

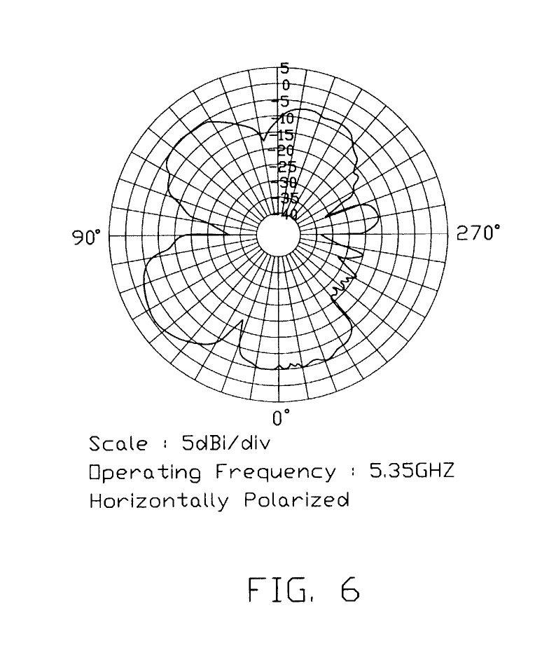

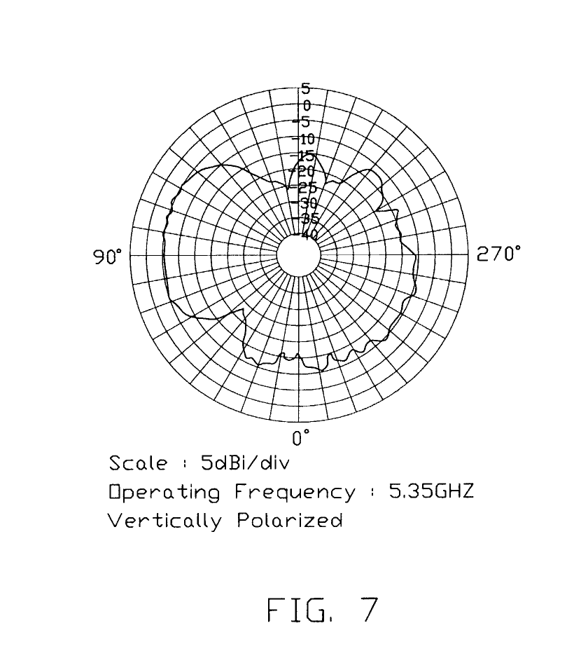

FIGS. 4-7 respectively show horizontally and vertically polarized principle plane radiation patterns of the dual band antenna 1 operating at frequencies of 2.5 GHz and 5.35 GHz (the principle plane is the X-Y plane shown in FIG. 2). Note that each radiation pattern is close to a corresponding optimal radiation pattern.

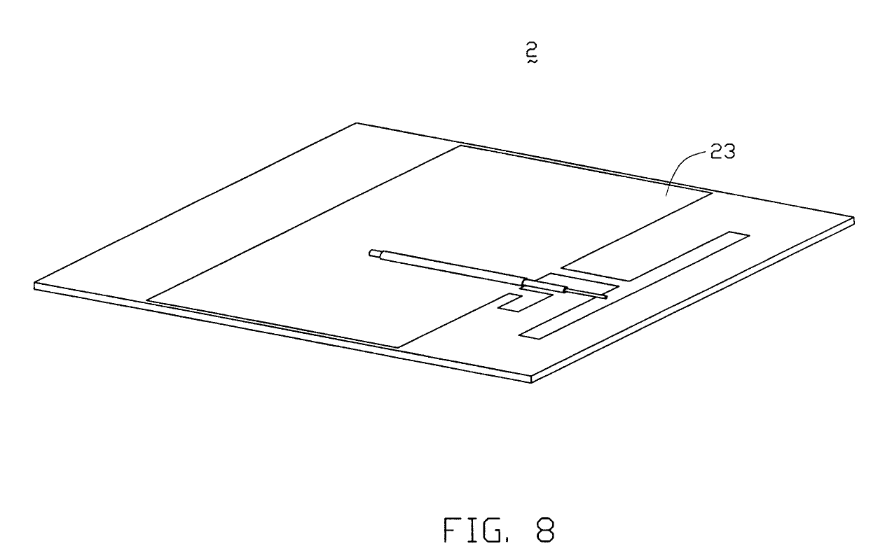

Referring to FIG. 8, a dual band antenna 2 according to a second embodiment of the present invention comprises a substantially rectangular ground portion 23. The ground portion 23 of the second embodiment is larger than that of the first embodiment. In this alternative embodiment, other elements of the dual band antenna 2 have constructions similar to those of the first embodiment, so a detailed description thereof is omitted herefrom.

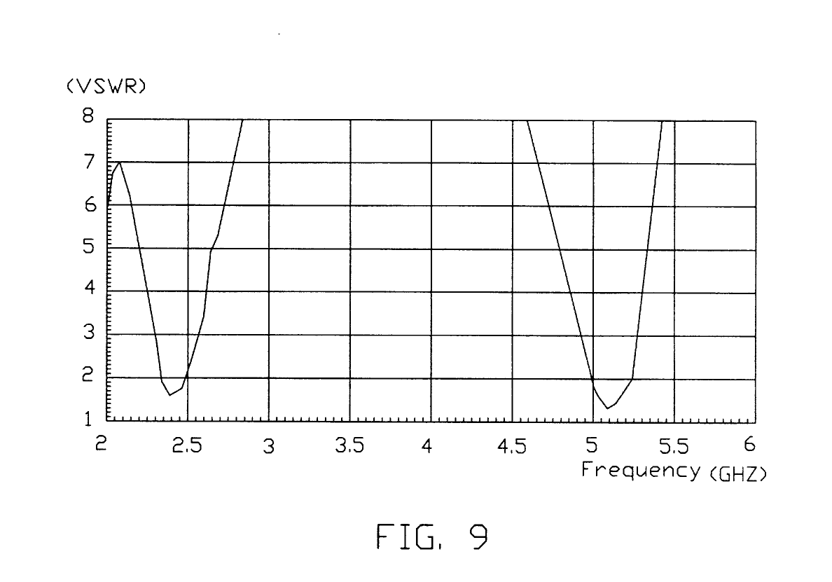

FIG. 9 shows a test chart recording of VSWR of the dual band antenna 2 as a function of frequency. Note that VSWR drops below the desirable maximum value “2” in the 2.45 GHz frequency band (2.35 GHz-2.47 GHz) and in the 5.25 GHz frequency band (5.00 GHz-5.24 GHz), indicating acceptably efficient operation in these two frequency bands.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A dual band antenna for an electronic device having a ground element, comprising:
an insulative substrate;
a planar conductive element disposed on the insulative substrate and comprising a first radiating portion, a second radiating portion and a ground portion, the first and the second radiating portions and the ground portion substantially disposed in a same plane, the ground portion adapted to electrically connect to the ground element of the electrical device; and
a feeder cable electrically connecting to the planar conductive element.

2. The dual band antenna as claimed in claim 1, wherein the first and the second radiating portions extend from a same edge of the ground portion.

3. The dual band antenna as claimed in claim 2, wherein the first radiating portion is T-shaped, and comprises a first radiating segment parallel to the ground portion and a first connection segment connecting the first radiating segment with the ground portion.

4. The dual band antenna as claimed in claim 3, wherein the second radiating portion is L-shaped and is partially surrounded by the first radiating portion, and the second radiating portion comprises a second radiating segment parallel to the ground portion, and a second connection segment connecting the second radiating segment with the ground portion.

5. The dual band antenna as claimed in claim 4, wherein the feeder cable comprises an inner core conductor and an outer shield conductor, and wherein the inner core conductor is electrically connected to the first radiating segment of the first radiating portion and the outer shield conductor is electrically connected to the ground portion.

6. The dual band antenna as claimed in claim 1, wherein the ground portion is configured to be striped-shaped.

7. The dual band antenna as claimed in claim 1, wherein the first radiating portion operates in a lower frequency band, and the second radiating portion operates in a higher frequency band.

8. An antenna comprising:
an insulative substrate comprising a planar major surface;
a planar conductive element disposed on the major surface of the substrate, the conductive element comprising a radiating portion and a ground portion; and
a coaxial feeder cable electrically connecting to the conductive element.

9. The antenna as claimed in claim 8, wherein the radiating portion comprises a first radiating section and a second radiating section.

10. An planar antenna assembly comprising:
an insulative substrate;
a planar conductive trace region disposed on the substrate, said region including:
a first radiating portion, a second radiation portion and a ground portion arranged along a first direction to be parallel with one another, the second radiating portion being located between said first radiating portion and said ground portion in a second direction perpendicular to said first direction, and dimensioned much shorter than those of said first radiating portion and ground portion along said first direction;
a first connection region extending along said second direction and connecting said first radiating portion and the ground portion;
a second connection region extending along said second direction and connecting second radiating portion and the ground portion; and
a cable disposed close to said second connection region and extending along said second direction with an inner core connecting to the first radiating portion and an outer shielding connecting to the ground portion.

11. The antenna as claimed in claim 10, wherein said first connecting region and said second connection region are both located on a same side with regard to said second radiating portion in said first direction.

12. The antenna as claimed in claim 11, wherein said cable is located between said first connection region and said second connection region in said first direction.
